(19) United States
(12) Patent Application Publication
(10) Pub. No.: US 2004/0212573 A1
(43) Pub. Date: Oct. 28, 2004

(54) Luminance compensation for emissive displays

(76) Inventors: Robert C. Sundahl, Phoenix, AZ (US); Lawrence A. Booth JR., Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/842,884

(22) Filed: May 10, 2004

Related U.S. Application Data
(62) Division of application No. 09/976,199, filed on Oct. 11, 2001.

(51) Int. Cl. H01J 1/62

(52) U.S. Cl. 345/82

(57) ABSTRACT

Briefly, this is a disclosure of embodiments of a technique, an apparatus, and a system for luminance compensation for emissive displays.

### BACKGROUND

1. Field

The present disclosure relates to the at least partial compensation of the luminance of an emissive display and, more particularly, to a method for adjusting such pixel luminance.

2. Background Information

A light emitting diode (LED) may be characterized as a semiconductor device specifically designed to emit light when voltage is applied across the diode with a polarity that provides a low-resistance conducting path, or forward bias. This light is typically emitted as one color that is substantially comprised of a narrow grouping of wavelengths in the visible spectrum, such as, for example, red, green, blue, or the invisible spectrum, such as, for example, light in the infrared color spectrum. Like a conventional diode, a LED often has a relatively low forward voltage threshold. Once this voltage threshold is exceeded, the LED generally has a relatively low impedance and conducts current readily. An organic light emitting diode (OLED) is a particular type of LED in which a series of carbon-based thin films based on organic compounds may be sandwiched between two, or more, electrodes.

A multitude of LEDs or OLEDs may be configured together in an array to create a display system. Such a display system, including an array of OLEDs, in some situations, may comprise an emissive display.

Emissive displays, in this context, refer to a broad category of display technologies that at least partially generate light that is emitted. Some examples may include: OLED displays, electro-luminescent displays, field emission displays, plasma displays, and vacuum florescent displays. In contrast, non-emissive displays typically employ a separate external source of light, such as, for example, the backlight of a liquid crystal display.

A trait common to several emissive displays is that the output signal of the emitters degrades with use. For example, one of the most common emissive displays, the cathode ray tube (CRT), which is often used in televisions and personal computer monitors, usually contains phosphors whose ability to output light degrades with the age of the display. The useful lifetime of emissive displays is, therefore, typically measured as the time it takes for the luminance of the display to degrade by 50%.

This phenomenon is often apparent when an image is displayed on part of a screen for extraordinarily long periods of time. After the image is removed from the screen, the area where the image was displayed may be noticeably darker than other areas of the screen. The original image is said to have been “burned-in” to the display and will often appear as a “ghost” image that seems superimposed with subsequent images that may be displayed in the same area of the screen. The emitters, which were used to display the “burned-in” image, may be thought to have become at least partially worn and are unable to display subsequent images as brightly as other emitters, which are less worn.

However, this degradation in the brightness or luminance of emissive displays is not limited to this extreme example. Use over time of one or more emitters of an emissive display often reduces the luminance of these emitters. As an example, despite images on a television's CRT frequently changing, a television's CRT is usually not as bright after a year of use as it was when first used.

This overall degradation behavior is frequently acceptable and possibly unnoticeable or barely noticeable if held within bounds or if it occurs over a relatively long period of time. However, the effect might be troublesome or undesirable if it occurred inconsistently at different locations of a display. This may happen because, as in the example above, one region of the display is used more frequently than the rest, as with, for example, the display of a logo. In such a circumstance, that region might age more rapidly and possibly exhibit the previously described burn-in effect. Alternately, this may happen because the display is tiled, such as sometimes occurs with flat-panel displays, for example, and the tiles of the display exhibit different aging characteristics. A need, therefore, exists for an approach or technique to address this display degradation issue.

### BRIEF DESCRIPTION OF THE DRAWINGS

Subject matter described hereinafter is particularly pointed out and distinctly claimed in the concluding portions of the specification. The claimed subject matter, however, both as to organization and the method of operation, together with objects, features and advantages thereof, may be best understood by a reference to the following detailed description when read with the accompanying drawings in which:

FIG. 1 is a graph illustrating typical current and luminance characteristics of a young organic light emitting diode (OLED);

FIG. 2 is a graph illustrating typical current and luminance characteristics of an aged organic light emitting diode (OLED);.

FIG. 3 is a graph illustrating possible shifts in voltage and luminance as a function of use for an organic light emitting diode (OLED), which may be used to adjust the luminance of the OLED; and

FIG. 4 is a diagram illustrating an embodiment of a circuit to adjust the luminance of an organic light emitting diode (OLED).

### DETAILED DESCRIPTION

In the following detailed description, numerous details are set forth in order to provide a thorough understanding of the claimed subject matter. However, it will be understood by those skilled in the art that the claimed subject matter may be practiced without these specific details. In other instances, well-known methods, procedures, components, and circuits have not been described in detail so as to not obscure the claimed subject matter.

Displays based upon OLED emitters may be operated with a substantially constant current drive. Under these conditions, degradation of the OLED may be exhibited by an increase in voltage utilized to maintain a substantially constant current drive, and/or a decrease in luminance produced by the OLED. This degradation may be proportional to the total amount of current passed through the diode during its useful life, and, thus, may be relatively insensitive to increases in the chronological age of the device. In addition, in some diode structures, temperature may accelerate the degradation of the device. At least in some circumstances this acceleration may be exponential with temperature.

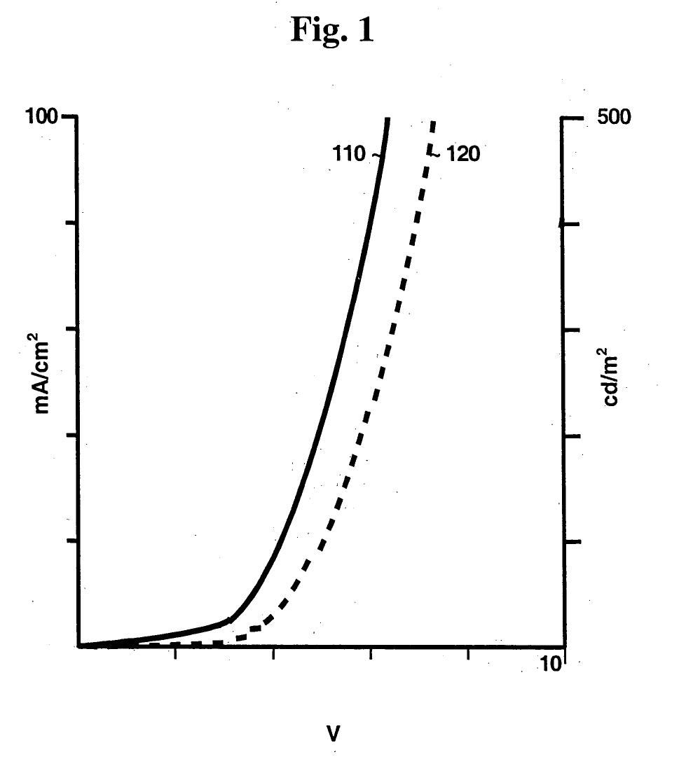

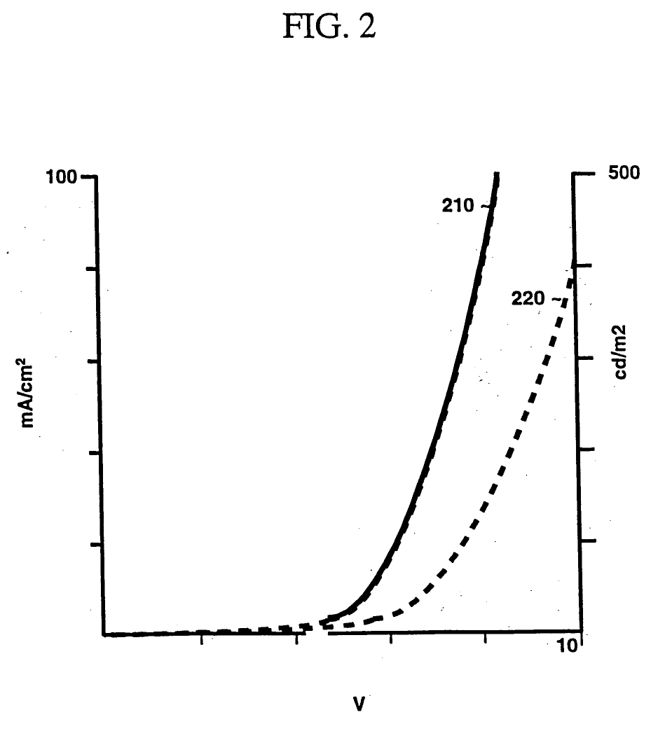

Typical output signal characteristics for an OLED device are illustrated in FIGS. 1 and 2. In this context, the terms “young” or “fresh” refer to a diode in which a relatively low level of total current has passed through the device during its useful life. Likewise, the terms “aged,” “old,” or “deteriorated,” in this context, refer to devices, which have had a relatively substantial amount of total current passed through the device. The terms do not refer to the chronological age of the OLED measured strictly or primarily by time. FIG. 1 illustrates a typical current and luminance characteristic of a fresh OLED.

In FIG. 1, the baseline curves which illustrate characteristics of a fresh OLED are shown. Curve 110, for example, depicts a possible relationship between instantaneous current (I) and voltage (V) for a diode that is relatively fresh. In addition, curve 120 illustrates a typical relationship between luminance (L), here measured in candelas per square meter (cd/m²), and voltage (V). Comparing curve 110 with curve 120 indicates a direct relationship between the current passing through the young diode and the luminance produced by the OLED.

In FIG. 2, similar typical characteristics of an at least partially deteriorated OLED are illustrated. In comparison to FIG. 1, due at least in part to the degradation of the OLED, the curves have shifted to the right. Comparing curve 110 (FIG. 1) with curve 220 indicates that to maintain a relatively constant current with an at least partially deteriorated device a higher voltage is applied than compared to the fresh device. Likewise, the luminance curve 220 has shifted from the fresh luminance curve 120. This illustrates that, as the OLED ages, more voltage and more current may be applied to the device to maintain a substantially constant luminance.

In one embodiment, a technique may be employed to approximately compensate for this degradation in the luminance of the OLED, such as, for example, increasing the substantially constant current through the OLED or the voltage across the OLED based at least in part upon the estimated deterioration of the OLED.

At least one desired result of this technique may be the production of a substantially consistent amount of luminance from all OLED pixels. Based upon the desired amount of luminance, a measured characteristic, such as, for example, the reverse bias resistance of the OLED, may be used to effectively estimate approximately how much current or voltage to apply to the device to produce such a result. This approach makes use of a previously defined relationship between the value of the indicator, such as, for example, reverse bias resistance, and the current (or voltage) utilized to maintain the desired level of luminance.

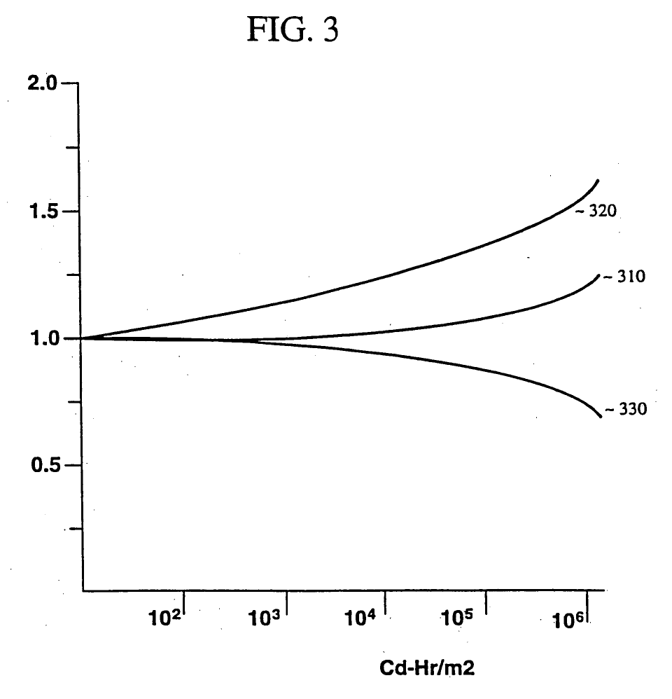

FIG. 3 illustrates ratios, which, for example, may be used in this embodiment to estimate the voltage to be applied to the OLED in order to achieve the desired substantially constant luminance. By measuring a particular characteristic of the OLED, one may estimate the effective age of the device and correct the current so as to provide a consistent luminance. For example, one might measure the forward voltage required to maintain a constant current over use. This information would identify the place on curve 310, which is a representation of the ratio of the voltage presently employed to produce the original current flow through the OLED over the original voltage employed to produce, substantially, the same current, or

$$\frac{V ( {I}_{o} )}{{V}_{o}} .$$

From this information one is then able to determine the voltage utilized at that point in the lifetime of the device to produce the substantially same luminance as the initial value Lₒ. The curve 320 represents a possible working curve,

$$\frac{V ( {L}_{o} )}{{V}_{o}} ,$$

for such a determination. This approach is similar to measuring the forward resistance of the diodes during use, and using the change in this value to determine the corrected voltage and current required to maintain a consistent luminance.

Other parameters may also be used to estimate the effective age of the device. For example, the reverse bias resistance of the OLED, may be measured while the device is in operation. However, one skilled in the art will recognize that there are many other characteristics of the OLED that may be measured and utilized. Characteristics, such as, forward bias resistance or the voltage across the OLED may be used; furthermore, there are many other possible characteristics, which may be measured or inferred. In addition, the desired characteristic in question need not be directly measured, but, instead, an indication of the effective age of the device may be estimated by obtaining a measurement that is correlated with or related to the desired characteristic.

In addition, the rate or frequency at which the characteristic may be measured varies along a large continuum of possible rates. At one extreme, the measurement may be taken nearly continuously or continually. In another example, it may be taken after some triggering or substantially, predetermined event occurs. For example, the characteristic may be measured when the display is turned on or reset. However, these are merely a few examples of the possible rates at which the characteristic may be measured and, of course, the claimed subject matter is not limited to any particular sampling rate or any sampling approach. Likewise, multiple characteristics may be measured and/or combined to provide a more definitive indication of degradation and required correction than available from a single set of measurements.

Once one has estimated the effective integrated luminance produced by the device, the voltage employed to produce the desired luminance may be estimated by the use of a curve, such as, 320, for example, which is a representation of the ratio of the voltage presently employed to produce the desired luminance over the voltage originally employed to produce that luminance, or

$$\frac{V ( {L}_{o} )}{{V}_{o}} .$$

Of course, the curve may change with the particular luminance desired, and the claimed subject matter is, therefore, not limited to the utilization of the curves illustrated in FIG. 3. Other curves, functions and ratios of voltage, current, luminance, resistance, or any one of a number of other related parameters are contemplated and may be used in alternate embodiments.

It is to be noted in FIG. 3 that the integrated current, or total charge, flowing through the device during its use may provide a measure of the “age” of the device. This parameter might be measured directly, and used to determine the voltage corretion required to maintain a desired luminance. However, an indirect indicator of the age of a particular diode, such as, for example, change in forward or reverse resistance may be a more convenient parameter to track. In FIG. 3, curve 310 provides the information about the relationship between the change in forward resistance and “age” that permits one to calculate the required change in voltage to maintain a desired luminance.

It is contemplated that an estimation of the voltage to apply may be accomplished through a variety of approaches. For example, an approximation of the ratio curves may be achieved via an analog control system. Likewise, the “curves” may be implemented as a digital look-up table or substantially computed by a series of machine accessible instructions.

Once the voltage to be applied to produce the desired luminance has been effectively estimated, the voltage or current through the OLED may be adjusted to achieve or nearly achieve that luminance. However, the claimed subject matter is not limited in scope to only manipulation of the current or voltage applied to the device.

The choice of desired luminance is not necessarily limited to the initial luminance of the device. For example, in one embodiment, the luminance of the OLED may be allowed to gracefully degrade as the device ages. Curve 330 of FIG. 3 illustrates a graceful degradation of luminance as a function of age. Luminance ratio curve 330 is a representation of the ratio of the luminance presently desired over the original luminance, or

$$\frac{L}{{L}_{o}} .$$

The previously described embodiment detailed an example where the desired luminance of the device is substantially constant and substantially equal to the original or initial luminance of the OLED. Other embodiments are contemplated where the desired luminance may be neither constant nor substantially equal to the original or initial luminance of the OLED. For example, it is contemplated that one embodiment may, for example, be created where the desired luminance of the OLED decreases as a function of the age of the. OLED. An example of such an embodiment is described below.

Because, the degradation, and hence the useful life, of the OLED is generally a function of the integrated luminance of the device, by decreasing the instantaneous luminance of the device, the useful life of the device may be increased. The useful life of emissive displays is typically measured as the time it takes for the luminance of the display to degrade by 50%. Since, a common trait of many emissive displays is that the output signal of the emitters degrade with use, a managed degradation of the display may be acceptable while increasing the useful life of the display.

The technique utilized in such an embodiment, for example, may be similar to the technique described with respect to the embodiment, previously described, where the desired luminance was substantially constant and substantially equal to the original or initial luminance of the OLED. Because, in this embodiment, the desired luminance decreases as a function of age, the desired luminance utilized in computing ratio curves 310 and 320 may change as a function of age. Hence, in this embodiment, where the desired luminance ratio is

$$\frac{L}{{L}_{o}} ,$$

curve 320 may be represented as

$$\frac{V ( L )}{{V}_{o}} ,$$

as opposed to

$$\frac{V ( {L}_{o} )}{{V}_{o}} .$$

In this embodiment, the desired controlled degradation might take a variety of forms. As a few, but not exhaustive, examples, the curves utilized to control degradation may be linear, exponential, non-continuous, or numerically generated. It is contemplated that the controlled degradation may occur gracefully to a substantially predetermined point and then be allowed to degrade more quickly. For example, because the useful life of emissive displays is usually measured as the time it takes for the luminance to degrade by 50%, the embodiment may allow a graceful degradation to the 50% point, although other points may be chosen, and then the device may cease to power the OLEDs or the OLEDs may be allowed to degrade without a compensating influence, such as, for example, one of the embodiments previously described.

Another embodiment may include a multitude of OLEDs, which are coupled in an array, or other possible configuration, to create an emissive display. In this context, an array is not limited to a rectilinear arrangement of rows and columns; but instead, any orderly or near orderly arrangement is considered an array in this context. In one embodiment all OLEDs may be tested, periodically or continually, to determine their age and desired voltage correction. In another embodiment, a representative or token number of OLEDs from the array may be measured in order to effectively estimate the age of both the measured and unmeasured OLEDs in the array. After the age of the sampled OLEDs has been estimated, this age may be used by a control system to adjust the current or voltage applied to the OLEDs in the array.

The strategy associated with the sampling is not limited to a constant fraction of OLEDs, or to a constant location of OLEDs in the display. it is anticipated that the measured changes can provide an indicator that would modify the number and location of measurements. In one of many possible embodiments, initial measurements would be made on a limited number of OLEDs, sampled in a changing random pattern on the display. Significant changes in one area of the display would provide an indication of a local significant change in degradation, requiring more detailed local sampling for correction.

There are a number of ways that the effective age of the display may be extrapolated from the sampled OLEDs. As just one example, the age of the sampled OLEDs may be averaged. Conversely, as another example, a sampled OLED may be utilized to control only the OLEDs which share the same or a substantially similar locality or usage characteristics. However, other techniques for extrapolating the age of the OLEDs comprising the emissive display are also contemplated.

In an additional embodiment, a multitude of arrays may be tiled together to form a large emissive display. Because the degradation characteristic of an emissive display often varies between manufacturing batches of the emissive displays, the individual tiles, which often come from different manufacturing batches, may degrade at different rates. In this embodiment, a particular control system may be employed to estimate the effective age and appropriate compensation adjustment to apply to a tile or set of pixels in the array. Likewise, multiple such control systems may be utilized to allow degradation compensation for an emissive display. In one approach, a number of these controls systems may be coupled in such a way that a control system receives not only the signals which provide the measured or inferred characteristics for the pixels which that control system may adjust but the control system may also receive signals which provide the measured or inferred characteristics for surrounding pixels or tiles, which that control system does not adjust. These additional signals may be used in such a way that their values affect the computation of the effective age or amount of compensation to apply to the pixels under that particular control system.

Just one, but not the only, example of how this information might affect the computation of the effective age, or amount of compensation, may involve an emissive display where a graceful degradation curve, such as, for example, curve 330, is utilized. If a tile or set of pixels in the display is used more often than the other tiles or sets of pixels in the display, the integrated luminance of the more frequently used tile or pixels will be higher than the unused tiles and, therefore, the computed effective age and, therefore, the desired luminance, as estimated with curve 330, of the frequently used tiles or pixels will be less than that of the other, less frequently used, tiles or pixels. The control system for that tile or set of pixels may, if acting without the signals from other tiles or sets of pixels, attempt to adjust the luminance ratio, to pick, without limitation, an arbitrary ratio for purposes of an example, to 0.75. However, other tiles, or sets of pixels may, if in isolation, be adjusted by their respective control systems to a luminance ratio, to pick, without limitation, another arbitrary ratio, of 0.85. Because the control systems, in this example, act substantially independently, the effect, known as “burn-in,” may still occur. However, if the control and measurement systems are coupled, as just described, for example, the control systems may adjust the luminance of the tiles or sets of pixels under their control to an average ratio of 0.80 or there about, for example.

Other techniques for weighting the coupled measurement signals may be utilized. A few, but not exhaustive, list of examples include: using a weighted average, median, or mode based at least in part upon area, locality, position, proximity or standard deviation of the measured characteristic or pixels in the display. In addition, further, but still not exhaustive, examples may include raising the luminance ratio of the display to the substantially highest expected value obtainable by all of the pixels or lowering the luminance ratio of all the pixels to the lowest value that is encountered. Many other approaches are also possible.

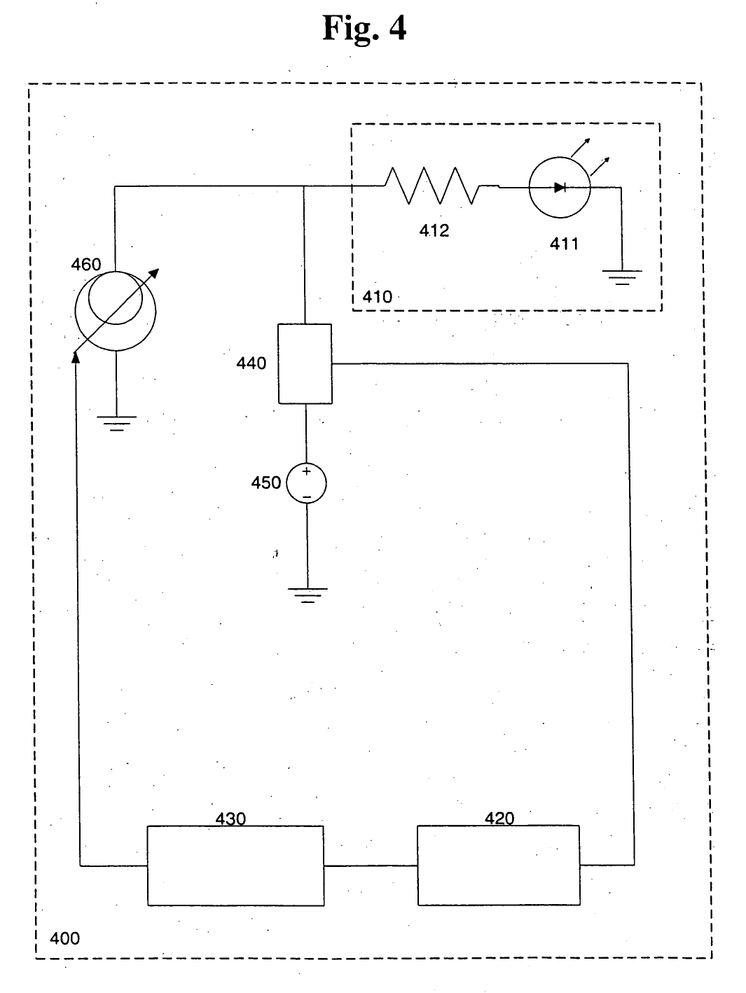

Another embodiment is illustrated in FIG. 4. During operation, OLED 410 may receive a substantially constant current from current source 460. Resistor 412 and ideal diode 411 shown in OLED 410 are merely convenient approximations or representations of the distributed properties of the OLED provided for purposes of illustration. Measurement device 440 may measure the analog voltage at the output point of current source 460 or the input point of OLED 410, and convert this measurement to a digital signal. While, in this example, measurement device 440 measures the voltage across OLED 410, the claimed subject matter is not limited to this particular measurement point or the measurement of this electrical characteristic. This digital signal may be input to coefficient modifier 420 which may change the coefficient stored in coefficient storage array 430. The control system, as illustrated by coefficient modifier 420 and coefficient storage array 430, may, as an example, be implemented as a digital logic block or a series of machine executable instructions. The coefficients stored in coefficient storage array 430 may then be used to produce a signal that adjusts the amount of current provided by current source 460, for example. By adjusting the amount of current provided by the current source, the degradation in the luminance of the OLED may be at least in part compensated.

In an additional embodiment, an array of OLEDs, a measurement circuit and a control system, as described in, but not limited to, any of the previous embodiments, may be coupled to a receiver in order to produce a stand-alone video display system. The receiver may receive a series of video signals in a digital format from another system, which transmits these signals. The receiver may then distribute and possibly reformat the video signals to the array of OLEDs for display.

While certain features of the claimed subject matter have been illustrated and described herein, many modifications, substitutions, changes, and equivalents will now occur to those skilled in the art. It is, therefore, to be understood that the appended claims are intended to cover all such modifications and changes that fall within the true spirit of the claimed subject matter.

What is claimed is:

1: A method for at least partially compensating luminance of an emissive display comprising:
estimating the amount of degradation of one or more organic light emitting diodes (OLEDs) included in said emissive display; and
adjusting the luminance of said one or more OLEDs based, at least in part, upon said estimate.

2: The method of claim 1, wherein adjusting comprises adjusting the luminance so that said luminance remains substantially constant substantially independent of the amount of degradation of said one or more OLEDs.

3: The method of claim 2, wherein estimating includes estimating a characteristic substantially correlated with said degradation.

4: The method of claim 3, wherein said estimating includes measuring the voltage across said one or more OLEDs at a substantially constant current flow through said one or more OLEDs.

5: The method of claim 2, wherein measuring said voltage across said one or more organic light emitting diodes (OLEDs) includes measuring the reverse bias resistance of said one or more OLEDs.

6: The method of claim 1, wherein adjusting includes adjusting the amount of electrical energy applied to said one or more organic light emitting diodes (OLEDs).

7: The method of claim 6, wherein adjusting includes increasing the voltage applied across said one or more OLEDs.

8: The method of claim 7, wherein increasing includes utilization of a lookup table.

9: The method of claim 8, wherein said lookup table includes values such that the luminance of said one or more organic light emitting diodes (OLEDs) achieved by the adjustment essentially decreases over time.

10: The method of claim 1, wherein said method further comprises adjusting the luminance of said one or more organic light emitting diodes (OLEDs) based, at least in part, upon estimating the amount of degradation of one or more other organic light emitting diodes (OLEDs).

11: An apparatus comprising:
one or more organic light emitting diodes (OLEDs);
a measurement circuit; and
a control system;
wherein said OLEDs, said measurement circuit and said contiol system are coupled so that, during operation, said measurement circuit, estimates the amount of degradation of said one or more OLEDS and said control system adjusts the luminance of said OLEDs, based at least in part upon said estimated degradation.

12: The apparatus of claim 11, wherein said control system is capable of adjusting the luminance so that said luminance remains substantially constant substantially independent of the amount of degradation of said one or more OLEDs.

13: The apparatus of claim 1, wherein the estimation of the amount of degradation, made by said measurement circuit, includes an estimation of a characteristic substantially correlated with said degradation.

14: The apparatus of claim 13, wherein said measurement circuit is capable of measuring the reverse bias resistance of said one or more organic light emitting diodes (OLEDs) operating at a substantially constant current.

15: The apparatus of claim 12, wherein said control system is capable of adjusting said luminance of said one or more organic light emitting diodes (OLEDs) by adjusting the substantially instantaneous current through said OLEDs.

16: The apparatus of.claim 11, wherein said control system comprises a series of data that correlates a desired luminance with the estimated degradation of said one or more OLEDs.

17: The apparatus of claim 16, wherein said control system utilizes said series of data to adjust the luminance of said one or more OLEDs.

18: The apparatus of claim 17, wherein said control system comprises a series of.data that correlates a desired luminance with the estimated degradation of said one or more OLEDs such that said desired luminance decreases as said estimated degradation of said one or more OLEDs increases.

19: The apparatus of claim 12, wherein said control system includes a storage medium having a plurality of machine accessible instructions, wherein, when said instructions are executed by said control system, the instructions provide for
utilizing a signal from said measuring circuit;
estimating a desired luminance for said OLEDs; and
adjusting the current applied to said OLEDs based at least in part upon said signal.

20: A system comprising:
a receiver which receives, from a source physically remote from said system, video signals in a digital format;
an array of one or more organic light emitting diodes (OLEDs);
a measurement circuit; and
a control system;
wherein said receiver disperses said digital signals to said array of OLEDs, and
wherein said array of OLEDs, said measurement circuit and said control system are coupled so that, during operation, said measurement circuit, estimates the amount of degradation of said one or more OLEDS and said control system adjusts the luminance of said OLEDs, based at least in part upon said estimated degradation.

21: The system of claim 20, wherein said control system is capable of adjusting the luminance so that said luminance remains substantially constant substantially independent of the amount of degradation of said array of OLEDs.

22: The system of claim 20, wherein the estimation of the amount of.degradation, made by said measurement circuit, includes an estimation of a characteristic substantially correlated with said degradation.

23: The system of claim 22, wherein said measurement circuit is capable of measuring the reverse bias resistance of said at least one OLED operating at a substantially predetermined current.

24: The system of claim 22, wherein said control system is capable of adjusting said luminance of said array of organic light emitting diodes (OLEDs) by adjusting the substantially instantaneous current through said array of OLEDs.

25: The system of claim 24, wherein control system includes a storage medium having a plurality of machine accessible instructions, wherein, when said instructions are executed by said control system, the instructions provide for
utilizing a signal from said measuring circuit;
estimating a desired luminance for said OLEDs; and
adjusting the current applied to said OLEDs based at least in part upon said signal.

26: The system of claim 24, wherein said control system comprises a series of data that correlates a desired luminance with the estimated degradation of said array of OLEDs and said control system utilizes said series of data to adjust the luminance of said array of - OLEDs.

27: The system of claim 26, wherein said control system comprises a series of data that correlates a desired luminance with. the estimated degradation of said one or more OLEDs such that said desired luminance decreases as said degradation of said one or more OLEDs increases.

28: The system of claim 21, wherein said control system comprises a plurality of control sub-systems, said respective sub-systems to adjust the output luminance of a particular respective sub-set of said array of one or more organic light emitting diodes (OLEDs).

29: The system of claim 28, wherein the organic light emitting diodes (OLEDs) of said array is coupled to a measurement circuit and control system which is capable of measuring the degradation of said respective OLEDs and is capable of respectively adjusting the luminance of said respective OLEDs.
